(19) United States
(12) Patent Application Publication
(10) Pub. No.: US 2004/0116018 A1
(43) Pub. Date: Jun. 17, 2004

(54) Method of making fibers, nonwoven fabrics, porous films and foams that include skin treatment additives

(75) Inventors: Christopher Dale Fenwick, Alpharetta, GA (US); Bryan David Haynes, Cumming, GA (US); Susan Carol Paul, Alpharetta, GA (US); Ali Yahiaoui, Roswell, GA (US); Varunesh Sharma, Atlanta, GA (US); David John Tyrrell, Appleton, WI (US); Bernard Joseph Minerath, Oshkosh, WI (US); Duane Gerard Krzysik, Appleton, WI (US); David William Koenig, Menasha, WI (US); Mark Bruce Majors, Cumming, GA (US); Braulio Arturo Polanco, Canton, GA (US); Matthew Boyd Lake, Cumming, GA (US); Earl David Brock, Appleton, WI (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/322,007

(22) Filed: Dec. 17, 2002

(51) Int. Cl. B32B 5/02; B32B 27/02

(52) U.S. Cl. 442/164; 442/59; 442/417

(57) ABSTRACT

The present invention provides fibers, foams, films and nonwoven fabrics having more than one skin treatment benefit and/or improved skin treatment benefit(s) and to products incorporated such fibers, foams, films and fabrics. The present invention also provides a method of forming fibers, nonwoven fabrics, porous films and foams with multiple skin treatment additives that impart a number of skin health attributes.

### FIELD

The present invention is direct to methods of making fibers, nonwoven fabrics, porous films and foams that include skin treatment additives and to fibers, nonwoven fabrics, films and foams that include skin treatment additives as well as products incorporating them.

### BACKGROUND

Nonwoven fabrics are useful for a wide variety of applications, including absorbent personal care products, garments, medical products, and cleaning products. Nonwoven personal care products include infant care items such as diapers, child care items such as training pants, feminine care items such as sanitary napkins, and adult care items such as incontinence products. Nonwoven garments include protective workwear and medical apparel such as surgical gowns. Other nonwoven medical products include nonwoven wound dressings and surgical dressings. Cleaning products that contain nonwovens include towels and wipes. Still other uses of nonwoven fabrics are well known. The foregoing list is not considered exhaustive.

Various properties of nonwoven fabrics determine the suitability of nonwoven fabrics for different applications. Nonwoven fabrics may be engineered to have different combinations of properties to suit different needs. Variable properties of nonwoven fabrics include liquid-handling properties such as wettability, distribution, and absorbency, strength properties such as tensile strength and tear strength, softness properties, durability properties such as abrasion resistance, and aesthetic properties.

The manufacture of nonwoven fabrics is a highly developed art. Generally, nonwoven fabrics and their manufacture involve forming filaments or fibers and depositing the filaments or fibers on a carrier in such a manner so as to cause the filaments or fibers to overlap or entangle. Depending on the degree of fabric integrity desired, the filaments or fibers of the fabric may then be bonded by means such as an adhesive, the application of heat or pressure, or both, sonic bonding techniques, or entangling by needles or water jets, and so forth. There are several methods of producing fibers or filaments within this general description; however, two commonly used processes are known as spunbonding and meltblowing and the resulting nonwoven fabrics are known as spunbond and meltblown fabrics, respectively.

Generally described, the process for making spunbond nonwoven fabrics includes extruding thermoplastic material through a spinneret, quenching and drawing the extruded material into filaments with a stream of high-velocity air to form a random web or fabric on a forming surface. Such a method is referred to as meltspinning. Spunbond processes are generally defined in numerous patents including, for example, U.S. Pat. No. 3,802,817 to Matsuki et al.; U.S. Pat. No. 4,692,618 to Dorschner, et al.; U.S. Pat. No. 4,340,563 to Appel, et al.; U.S. Pat. Nos. 3,338,992 and 3,341,394 to Kinney; U.S. Pat. No. 3,502,538 to Levy; U.S. Pat. Nos. 3,502,763 and 3,909,009 to Hartmann; U.S. Pat. No. 3,542,615 to Dobo, et al.; and Canadian Patent No. 803,714 to Harmon.

On the other hand, meltblown nonwoven fabrics are made by extruding a thermoplastic material through one or more dies, blowing a high-velocity stream of air, usually heated air, past the extrusion dies to generate an air-conveyed meltblown fiber curtain and depositing the curtain of fibers onto a forming surface to form a random nonwoven web or fabric. Meltblowing processes are generally described in numerous publications including, for example, an article titled “Superfine Thermoplastic Fibers” by Wendt in Industrial and Engineering Chemistry, Vol. 48, No. 8, (1956), at pp. 1342-1346, which describes work done at the Naval Research Laboratory in Washington, D.C.; Naval Research Laboratory Report 111437, dated Apr. 15, 1954; U.S. Pat. Nos. 4,041,203, 3,715,251, 3,704,198, 3,676,242 and 3,595,245; and British Specification 1,217,892.

Spunbond and meltblown nonwoven fabrics can usually be distinguished by the diameters and the molecular orientation of the filaments or fibers which form the fabrics. The diameter of spunbond and meltblown filaments or fibers is the average cross-sectional dimension. Spunbond filaments or fibers typically have average diameters greater than 6 microns and often have average diameters in the range of 12 to 40 microns. Meltblown fibers typically have average diameters of less than 6 microns. However, because larger meltblown fibers, having diameters of at least 6 microns may also be produced, molecular orientation can be used to distinguish spunbond and meltblown filaments and fibers of similar diameters. For a given fiber or filament size and polymer, the molecular orientation of a spunbond fiber or filament is typically greater than the molecular orientation of a meltblown fiber. Relative molecular orientation of polymeric fibers or filament can be determined by measuring the tensile strength and birefringence of fibers or filaments having the same diameter.

Tensile strength of fibers and filaments is a measure of the stress required to stretch the fiber or filament until the fiber or filament breaks. Birefringence numbers are calculated according to the method described in the spring 1991 issue of INDA Journal of Nonwovens Research, (Vol. 3, No. 2, p. 27). The tensile strength and birefringence numbers of polymeric fibers and filaments vary depending on the particular polymer and other factors; however, for a given fiber or filament size and polymer, the tensile strength of a spunbond fiber or filament is typically greater than the tensile strength of a meltblown fiber and the birefringence number of a spunbond fiber or filament is typically greater than the birefringence number of a meltblown fiber.

Despite prior advances in the art, there is still a need to provide improved nonwoven fabrics that include more than one skin treatment additive and to provide methods of making nonwoven fabrics that provide multiple skin treatment benefits.

### SUMMARY

In response to the difficulties and problems encountered in the prior art, new materials and methods of making materials have been discovered. In one embodiment, the present invention provides a method of forming a fiber, a nonwoven fabric, a porous film or a foam comprising: (a) blending a thermoplastic resin and at least one melt additive, wherein the at least one melt additive is a first skin treatment additive; (b) forming a fiber, a nonwoven fabric, a porous film or a foam from a blend comprising the thermoplastic resin and the at least one melt additive; and (c) attaching at least one external additive on at least a portion of the outer surface of the fiber, nonwoven fabric, porous film or foam wherein the at least one external additive is a second skin treatment additive. The at least one external additive can be deposited on at least a portion of the outer surface of the fiber, nonwoven fabric, porous film or foam by a step selected from the group consisting of: (a) electrostatic pinning of particles of a skin treatment additive or particles that include at least one external additive on at least a portion of the outer surface of the fiber, nonwoven fabric, porous film or foam; (b) spraying a solution, emulsion or other mixture comprising the at least one external additive on at least a portion of the outer surface of the fiber, nonwoven fabric, porous film or foam; (c) heating at least a portion of the outer surface of the fiber, nonwoven fabric, porous film or foam and then depositing particles comprising at least one external additive on at least a portion of the outer surface of the fiber, nonwoven fabric, porous film or foam; (d) heating at least a portion of the outer surface of the fiber, nonwoven fabric, porous film and depositing particles comprising at least one external additive on at least a portion of the outer surface of the fiber, nonwoven fabric, porous film or foam; (e) depositing particles comprising the at least one external additive on at least a portion of the outer surface of fiber, nonwoven fabric, porous film or foam and then heating at least the portion of the outer surface of the fiber, nonwoven fabric porous film or foam; and (f) coating or attaching the at least one external additive on at least a portion of the outer surface of fiber, nonwoven fabric, porous film or foam. The melt additive(s) can be selected from the group consisting of polydimethyl siloxane compounds, alkyl silicones, phenyl silicones, amine-functional silicones, silicone gums, silicone resins, silicone elastomers, dimethicones, dimethicone copolyols and lipids and derivatives thereof. For example the melt additive may include a sterol and or a phytosterol and may comprise from about 0.1 weight percent to about 10 weight percent of the fiber, nonwoven fabric, porous film or foam, or from about 0.25 weight percent to about 5 weight percent the fiber, nonwoven fabric, porous film or foam and even from about 1 weight percent to about 2 weight percent of the fiber, nonwoven fabric, porous film or foam. The external additive(s) can be selected from the group consisting of botanical extracts, clay particles, talc particles, boron nitride particles, corn starch, zeolites, zinc oxide, hyaluronic acid, glycerin and related polyols, chitosan and chemically-modified sulfated chitosans.

In one particular embodiment, the present invention provides a method of forming a fiber, a nonwoven fabric, a porous film or a foam, the method comprising blending a thermoplastic resin and at least one melt additive, wherein the at least one melt additive is a lipid, and forming a fiber, a nonwoven fabric, a porous film or foam from the blend comprising the thermoplastic resin and the lipid.

In yet another embodiment, the present invention provides multicomponent fibers comprising a blend that comprise a thermoplastic resin and at least one skin treatment additive, wherein the fiber has an outer surface and at least a portion of the outer surface comprises a second skin treatment additive. The first skin treatment additive can be selected from the group consisting of polydimethyl siloxane compounds, alkyl silicones, phenyl silicones, amine-functional silicones, silicone gums, silicone resins, silicone elastomers, dimethicones, dimethicone copolyols and lipids and derivatives thereof, for example dimethicone, a sterol or a phytosterol particularly soy sterol, and may comprise from about 0.1 weight percent to about 10 weight percent of the multicomponent fiber, or from about 0.25 weight percent to about 5 weight percent the multicomponent fiber and even from about 1 weight percent to about 2 weight percent of the multicomponent fiber. The second skin treatment additive can be selected from the group consisting of botanical extracts, clay particles, particularly clay particles that have an average particle size that is less than 500 micrometers, talc particles, boron nitride particles, corn starch, zeolites, zinc oxide, hyaluronic acid, glycerin and related polyols, chitosan and chemically-modified sulfated chitosans. The present invention also provides nonwoven fabrics comprising such multicomponent fibers and absorbent articles such as bandages and personal care products such as diapers comprising such nonwoven fabrics and fibers.

### BRIEF DESCRIPTION OF THE DRAWINGS

FIG. 1(a) is a scanning electron micrograph of a comparative example of bicomponent spunbonded fibers that do not include an external skin health additive.

FIG. 1(b) is a scanning electron micrograph of an example of the present invention that shows bicomponent spunbonded fibers that include a soy sterol as a internal skin health additive and clay particles as an external skin health additive.

FIG. 2 is a schematic illustration of one method of making a nonwoven fabric and bicomponent fibers.

FIG. 3 illustrates an exemplary process for topically applying of a composition that includes a treatment additive to a nonwoven fabric.

FIG. 4 illustrates an exemplary saturation or dip and squeeze method for topically applying a composition that includes a treatment additive to a nonwoven fabric.

### DEFINITIONS

As used herein the following terms have the specified meanings, unless the context demands a different meaning, or a different meaning is expressed; also, the singular generally includes the plural, and the plural generally includes the singular unless otherwise indicated.

Words of degree, such as “about”, “substantially”, and the like are used herein in the sense of “at, or nearly at, when given the manufacturing and material tolerances inherent in the stated circumstances” and are used to prevent the unscrupulous infringer from unfairly taking advantage of the invention disclosure where exact or absolute figures are stated as an aid to understanding the invention.

As used herein, the term “absorbent product” or “personal care absorbent product” means diapers, training pants, swim wear, absorbent underpants, adult incontinence products, sanitary wipes, wipes, feminine hygiene products, wound dressings, nursing pads, time release patches, bandages, mortuary products, veterinary products, hygiene and so forth.

As used herein, the terms “comprises”, “comprising” and other derivatives from the root term “comprise” are intended to be open-ended terms that specify the presence of any stated features, elements, integers, steps, or components, but do not preclude the presence or addition of one or more other features, elements, integers, steps, components, or groups thereof.

As used herein, the term “fabric” refers to all of the woven, knitted and nonwoven fibrous webs.

As used herein, the term “fiber” refers to a threadlike object or structure from which textiles and nonwoven fabrics are commonly made. The term “fiber” is meant to encompass both continuous and discontinuous filaments, and other threadlike structures having a length that is substantially greater than its thickness or diameter.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a forming surface to form a web of randomly dispersed meltblown fibers. Such a process is disclosed, for example, in U.S. Pat. No. 3,849,241 to Butin et al. Meltblown fibers are microfibers, which may be continuous or discontinuous, are generally smaller than 10 microns in average diameter, and are generally tacky when deposited onto a forming surface.

As used herein “multilayer laminate” means a laminate including two or more layers of material laminated into a composite structure. For example, one or more of the layers may be a spunbond layer and/or some of the layers may be a meltblown layer. One specific example of a multilayer laminate is a spunbond/meltblown/spunbond (SMS) laminate. Other multilayer laminates are disclosed in U.S. Pat. No. 4,041,203 to Brock et al., U.S. Pat. No. 5,169,706 to Collier, et al, U.S. Pat. No. 5,145,727 to Potts et al., U.S. Pat. No. 5,178,931 to Perkins et al. and U.S. Pat. No. 5,188,885 to Timmons et al. A multilayer laminate may be made by sequentially depositing onto a moving forming belt first a spunbond fabric layer, then a meltblown fabric layer and last another spunbond layer and then bonding the laminate in a manner described below. Alternatively, the fabric layers may be made individually, collected in rolls, and combined in a separate bonding step. Such fabrics usually have a basis weight of from about 0.1 to 12 ounces per square yard (3 to 400 grams per square meter), or more particularly from about 0.75 osy to about 3 osy. Multi-layer laminates may also have various numbers of meltblown layers or multiple spunbond layers in many different configurations and may include other materials like films (F) or coform materials, e.g. SMMS, SM, SFS, and so forth.

As used herein the terms “nonwoven” and “nonwoven fabric or web” mean a web having a structure of individual fibers, filaments or threads which are interlaid, but not in an identifiable manner as in a knitted fabric and is meant to include fibrillated films. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

As used herein the term “spunbonded webs” refers to webs comprising small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a forming surface. Spunbond fibers are generally continuous and have average diameters (from a sample of at least 10) larger than 7 microns, more often, between about 10 and 20 microns.

These terms may be defined with additional language in the remaining portions of the specification.

### DETAILED DESCRIPTION

As discussed above, the present invention provides a method of forming a fiber, a nonwoven fabric, a porous film or a foam that includes: (a) blending a thermoplastic resin and at least one melt additive, wherein the at least one melt additive is a first skin treatment additive; (b) forming a fiber, a nonwoven fabric, a porous film or a foam from a blend comprising the thermoplastic resin and the at least one melt additive; and (c) attaching at least one external additive on at least a portion of the outer surface of the fiber, nonwoven fabric, film or foam wherein the at least one external additive is a second skin treatment additive. The external skin health additive may be the same skin health additive as the internal skin health additive or, in most instances, is a skin health additive that is a different skin health additive than the internal, skin health additive. The present invention also provides fibers, nonwoven fabrics, films and foams that include one or more skin treatment additives that provide skin treatment benefit(s). Fibers, nonwoven fabrics, films and foams that include one or more skin treatment additives are useful as components of personal care absorbent products such as diapers, training pants, adult incontinence products, sanitary wipes, infant and adult wet wipes, skin cleansing wipes, dry wipes, industrial wipes, feminine hygiene products, wound dressings, bandages, bath tissue, facial tissue and so forth. For example, synthetic fibers of the present invention may be incorporated into cellulosic base sheet of a bathroom tissue, facial tissue or other wipe that includes cellulosic fibers.

Many of the components of personal care absorbent products, for example fibers, nonwoven fabrics, films and foams, are made of thermoplastic resins. Thermoplastic resins are polymers, typically synthetic polymers, that are thermally processable. Thermoplastic resins can be softened with heat and formed into shaped objects, such as fibers and films, which can then be converted into final products such as diapers. Thermoplastic resins are readily available and well known. A wide variety of thermoplastic resins are suitable for the present invention. Suggested thermoplastic resins suitable for the present invention include, but are not limited to: polyolefins, such as polyethylene, polypropylene and polybutylene; polyesters; polyamides; thermally processable polymers and copolymers of lactic acid; polyurethanes; and so forth. Suggested polyolefins include, but are not limited to, polyethylenes, polypropylenes and polymers and copolymers of ethylene and propylene. And, suggested commercially available examples of polyolefin resins include 3445 polypropylene from Exxon of Houston, Tex. and XUS 61800.41 polyethylene from Dow Chemical Company of Midland, Mich. The present invention is demonstrated by the use of 3445 polypropylene as a first polyolefin in a side-by side bicomponent fiber and XUS 61800.41 polyethylene as a second polyolefin in a side-by side bicomponent fiber in the Examples that follow.

Generally, skin treatment additives include any chemical, composition or substance that will prevent or lessen the effect(s) of skin irritation or supplement the barrier composition of the skin or provide one or more skin treatment benefit. A skin treatment additive may be incorporated internally into a composition that is used to form fibers, nonwoven fabrics, films or foams and/or may be topically applied to the surface or exterior of fibers, nonwoven fabrics, films or foams depending, among other things, on the thermal stability of the selected skin treatment additive and the ability of the selected skin treatment additive to withstand the conditions required to form the fiber, fabric, film or foam. In some embodiments, it is desirable that the internal additive(s) blooms to the surface of the fiber, fabric, film or foam. Fibers, fabrics, films and foams of the present invention may further include additional internal and/or external additives such as: compositions that enhance cleansing e.g. surfactants; botanical extracts; scents; and other skin care ingredients such as orange blossom, rose, jasmine, linden flower and other extracts; and odor controlling or odor mediating compositions.

Skin treatment additives that may be incorporated internally into a composition that is used to form fibers, nonwoven fabrics, films or foams include skin treatment additives that are able to withstand the processing conditions required to form the fibers, nonwoven fabric, film or foam. Suggested skin treatment additives that may be incorporated internally will include such organic compounds, for example organosilicones, that provide a skin treatment benefit. Suggested internal skin treatment additives are thermally stable under the processing conditions required to melt blend the skin treatment additive and the thermoplastic resin. It is also desirable that an internal skin treatment additive migrates or “blooms” to the surface of the fiber, fabric, film or foam so that the additive is available on the surface of the fiber, fabric, film or foam. Thus, the relative amount of skin treatment additive that will contact a wearer of the fiber, fabric, film or foam is increased. Blooming may replenish the skin treatment additive available at the surface. Suggested skin treatment additives that may be incorporated internally include, but are not limited to: emollients such as dimethicones and derivatives thereof, petrolatum, white petrolatum, mineral oil, and lipids such as sterols, phytosterols, soy sterol and derivatives thereof.

As previously stated, a skin treatment additive that will not breakdown at elevated temperatures that the skin treatment additive will encounter during melt processing can be used internally. For example, soy sterol is stable at temperatures at which most polyethylene and polypropylene resins are extruded and thus can be melt blended or otherwise processed with most polyethylene and polypropylene resins. For example, it is desirable that a skin treatment additive that is internal and is melt blended with the thermoplastic resin is thermally stable to at least about 410° F. (about 210° C.). It is even more desirable that such an internal skin treatment additive is thermally stable to at least about 450° F. (about 230° C.). If the thermoplastic resin has a high melt processing temperature, for example a polyester, the internal skin treatment additive may need to be thermally stable up to about 500° F. (about 260° C.). It is also desirable that the internal additive(s) is not highly volatile and is sufficiently soluble in the molten or semi-molten thermoplastic resin.

One suggested class of internal skin treatment additives that may be incorporated as a melt additive includes polysiloxane compounds. One particularly suggested class of internal skin treatment additives that may be incorporated as a melt additive includes dimethicones. As used herein, “dimethicones” includes various polysiloxane compounds having the general formula CH₃[Si(CH₃)₂O]ₓSi(CH₃)₃ and includes mixtures of fully methylated linear siloxane polymers end blocked with trimethylsiloxy units with a range in viscosity form 0.65 to 1,000,000 centistokes at room temperature. Dimethicones are immiscible in water but are miscible with ethers, such as ethyl ether, and with chloroform. Another suggested class of polysiloxane compounds includes alkyl silicones. Examples of suitable alkyl silicones include, but are not limited to, the following compounds: C₂₄-C₂₈ alkyl dimethicone, C₃₀ alkyldimethicone, cetyl methicone, stearyl methicone, cetyl dimethicone, stearyl dimethicone, cerotyl dimethicone and phenyl dimethicone. Alky substituted polysiloxanes may be used as an internal skin treatment additive. Suggested alky substituted polysiloxanes include alkyl polysiloxanes substituted with one or more amino, carboxyl, hydroxyl, ether, polyether, aldehyde ketone, amide ester an/or thiol groups. In one suggested embodiment, at least one wetting agent is incorporated into or otherwise added to the polyolefin resin before the resin is formed into fibers, a nonwoven fabric or a film. Desirably, the wetting agent is a surfactant and more desirably the wetting agent is a silicon-based surfactant, such as an ethoxylated siloxane. The surfactant changes the surface interaction of the fibers and/or nonwoven fabric to a liquid, desirably an aqueous liquid. MASIL SF19 surfactant is dimethicone copolyol and is an ethoxylated siloxane, more precisely an ethoxylated trisiloxane, even more precisely a trisiloxane with ethylene oxide groups, and includes both ethoxylated monoglycerides and diglycerides. MASIL SF19 surfactant can be obtained from BASF (formerly a product of PPG) of Gurnee, Ill. The wetting agent or dimethicone can be incorporated into or otherwise added to the thermoplastic resin in any known manner. For example, a wetting agent and dimethicone can be compounded with a thermoplastic resin or another resin and then added to the thermoplastic resin used to form the fibers, fabric, film or foam by direct injection into an extruder or can be incorporated into the thermoplastic resin by compounding prior to fiber or foam forming or fabric or film making.

Another suggested class of internal skin treatment additives that may be incorporated as a melt additive includes lipids. In one suggested embodiment, a lipid is included as an internal skin treatment additive in a composition and a method of the present invention. Lipids that are thermally stable under processing conditions can be incorporated into or otherwise added to the thermoplastic resin before the resin is formed into a fiber, a nonwoven fabric or a film are desirable. Lipids are generally fats and fat-derived materials that include, but are not limited to, organic compounds such as fats, fatty acid esters, fatty alcohols, steroid alcohols, oils, waxes, sterols and glycerides that are relatively insoluble in water but soluble in organic solvents such as benzene, chloroform, acetone, ethers and so forth. Examples of lipids are well known. Suggested examples of lipids include sterols of both animal and plant origin. An example of a suggested phytosterol, a sterol of plant origin, is ergosterol. A suggested commercially available example of phytosterol is GENEROL 122 N PRL refined soy sterols from Cognis Corporation of Cincinnati, Ohio. The present invention is demonstrated by the use of GENEROL 122 N PRL soy sterols in the Examples that follow. Other examples of suggested lipids include, but are not limited to, lanolin, triglycerides such as castor oil, borage oil, linseed oil, and rapeseed oil.

The first skin treatment additive and any other additional additive or component such as processing aid can be incorporated in a thermoplastic composition by melt blending a mixture or other combination of the additive(s) and the base thermoplastic resin. Processes of melt blending are well known and include processes such as making a masterbatch of the additive and a resin and then combining the masterbatch and the base thermoplastic resin. An additive and a thermoplastic resin can be combined and melt blended in, for example, an extruder, to effectively uniformly mix the additive and a thermoplastic resin such that an essentially homogeneous melted mixture is formed. The essentially homogeneous melted mixture may then be cooled and pelletized for later processing or can be extruded into a film for example. Alternatively, the melted mixture may be sent directly to a spin pack or other equipment for forming fibers or a nonwoven fabric. Other methods of mixing together the components of the present invention are also possible and will be easily recognized by one skilled in the art. For example, an additive can also be metered directly into the extruder using a cavity mixer directly connected to the extruder.

The skin treatment additive can be included in the melt mixture at varying concentrations. However, it is suggested that the skin treatment additive can be included in at a concentration of from about 0.1 weight percent to about 10 weight percent of internal additive to weight of fiber, fabric, film, foam or component of a multicomponent structure. More suggested internal additive concentrations range from about 0.25 weight percent to about 5 weight percent internal additive to weight of the fiber, fabric, film, foam or component of a multicomponent structure. And even more suggested internal additive concentrations range from about 1 weight percent to about 2 weight percent internal additive to weight of fiber, fabric, film, foam or component of a multicomponent structure. It should be noted that the additive concentration can vary greatly and will depend on the efficacy, processability and cost of the additive, among other factors.

A thermoplastic composition that includes a thermoplastic resin and at least one first internal skin treatment additive may be formed into or otherwise processed into various articles or shapes such as fibers, nonwoven fabrics, films or foams which are useful as skin contacting components of personal care articles. Methods of making fibers, nonwoven fabrics, films and foams are well known. Nonwoven fabrics are particularly desirable for personal care application because of their breathability. Methods of forming nonwoven fabrics are known and include meltspinning and spunbonding processes as defined above.

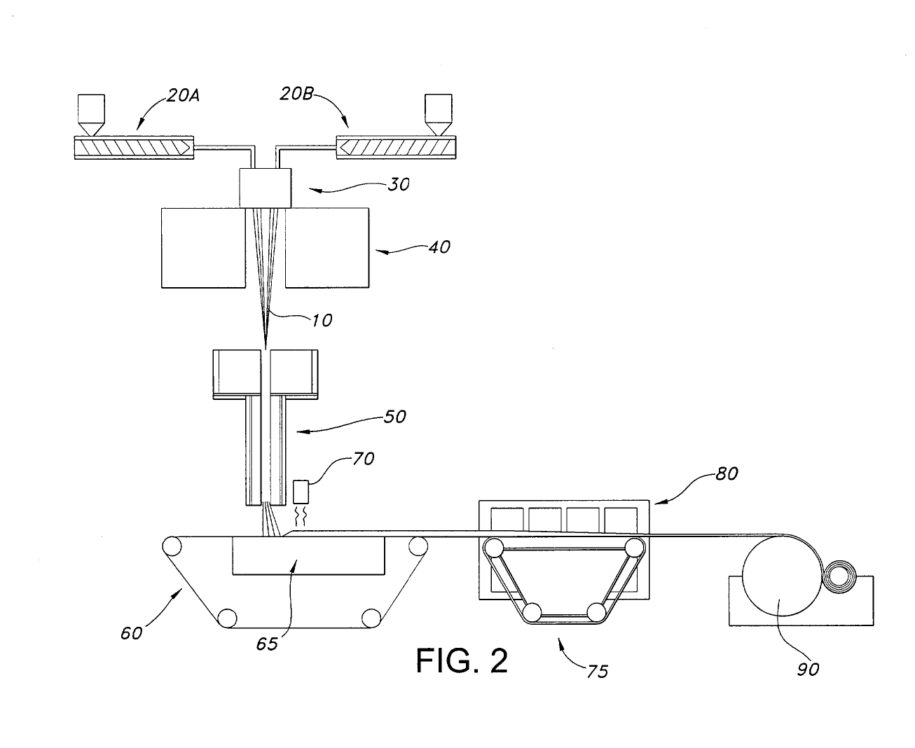

The present invention is illustrated in an exemplary embodiment by a method of making a nonwoven fabric that includes forming bicomponent continuous filaments and a spunbonded fabric from a melt mixture of a thermoplastic resin and a skin treatment additive, e.g. soy sterol and/or dimethicone. Although the present invention is illustrated via a method of making a bicomponent spunbonded fabric, methods of making films and foams from the compostions described herein are possible, as well as other methods of making nonwoven fabrics and fibers and will be easily recognized by those skilled in the art. Turning to FIG. 2, an exemplary method of the present invention is illustrated and described herein. FIG. 2 illustrates a process line that is arranged to produce bicomponent continuous filaments and spunbonded fabrics. It should also be understood that the present invention comprehends nonwoven fabrics made with single component filaments; mixtures of filaments including cellulose-based filaments, staple fibers and/or multicomponent filaments having more than two components; and so forth as well as other types of nonwoven fabrics and films and foams. It may also be desirable to use shaped fibers such as pentalobal fibers, tri-T shaped fibers, H-shaped fibers, x-shaped fibers and other shaped fibers that are known in the art. It is believed that the use of shaped fibers may increase the particle capture efficiency of the fibers and nonwoven fabrics that include such fibers.

The illustrated process line includes two extruders 20A and 20B. First extruder 20A extrudes the primary polymer component A and a second, separate extruder 20B extrudes adhesive polymer component B. In the example below, primary polymer component A was 3445 polypropylene from Exxon of Houston, Tex. and the adhesive component B was XUS 61800.41 polyethylene from Dow Chemical Company of Midland, Mich. Polymer component A is fed into extruder 20A from a first hopper and polymer component B is fed into extruder 20B from a second hopper. A skin treatment additive may be fed into either or both extruders 20A and 20B or included in either or both components A or B prior to the components being fed into their respective extruder.

In one suggested embodiment, fibers or nonwoven fabrics of the present invention are or include multicomponent fibers, for example bicomponent fibers, so that the amount of internal skin treatment additive needed in the overall fiber or fabric can be reduced. For example, a bicomponent fiber of the present invention may include a fiber having a core of polypropylene and a sheath of the same polypropylene including a skin treatment additive to reduce the overall amount of skin treatment additive needed while decreasing adverse affects of the skin treatment additive, if any, on processability. Multicomponent fibers, including bicomponent fibers, are well known. Suggested configurations of bicomponent fibers include, side-by-side configurations and sheath-core configurations. Side-by-side configurations and sheath-core configurations of bicomponent and other multicomponent fibers are also well known. Multicomponent and bicomponent fibers, as used herein may include, multicomponent and bicomponent fibers in which one base polymer is used for more than one component where one component includes an additive or other compound in a differing amount than the other component(s). Multicomponent fibers are well known as are described in U.S. Pat. No. 5,382,400 to Pike et al. which is hereby incorporated herein by reference.

From the extruders, the polymer components pass through respective polymer conduits to a spinneret 30. Spinnerets for extruding bicomponent filaments are known to those skilled in the art and thus are not described here in detail. Generally described, the spinneret 30 includes a housing containing a spin pack which includes a plurality of plates stacked one on top of the other with a pattern of openings arranged to create flow paths for directing polymer components A and B separately through the spinneret 30. The spinneret 30 has openings arranged in one or more rows. The spinneret openings form a downwardly extending curtain of filaments 10 when the polymers are extruded through the spinneret 30. For the purposes of the present invention, spinneret 30 may be arranged to form side-by-side or sheath/core bicomponent filaments or other types of filaments. The illustrated process line also includes a quench air blower 40 positioned adjacent the curtain of filaments extending from the spinneret 30. Air from the quench blower 40 quenches the filaments extending from the spinneret 30. The quench air can be directed from one side of the filament curtain or both sides of the filament curtain as illustrated.

A fiber draw unit (FDU) or aspirator 50 is illustrated below the quench air blower 40 and receives the quenched filaments. Fiber draw units or aspirators for use in melt spinning polymers are known. Suitable fiber draw units for use in the process of the present invention include a linear fiber aspirator of the type described and illustrated in U.S. Pat. No. 3,802,817, linear draw system of the type described and illustrated in U.S. Pat. No. 4,340,563 and eductive guns of the type described and illustrated in U.S. Pat. Nos. 3,692,618 and 3,423,266, all of which are hereby incorporated herein by reference. Generally, the fiber draw unit 50 includes an elongate vertical passage through which filaments are drawn by aspirating air entering from the sides of the passage and flowing downwardly through the passage. A shaped, endless, and at least partially foraminous, forming surface 60 is positioned below the fiber draw unit 50 to collect and receive continuous filaments from the outlet opening of the fiber draw unit. The forming surface 60 may be a belt that travels around guide rollers as illustrated to provide a continuous process. Desirably, a vacuum 65 is positioned below the forming surface 60 where the filaments are deposited to draw the filaments against the forming surface 60. Although the forming surface 60 is illustrated as a belt in FIG. 2, it is understood that the forming surface can also be in other forms, for example a drum.

In the embodiment illustrated in FIG. 2, the filaments that have been collected on a forming surface are exposed to a hot-air knife (HAK) 70 that provides some integrity to the fabric so that the fabric can be transferred to another wire. Transfer of a fabric can be accomplished without the use of a HAK and by other methods including but not limited to, vacuum transfer, compaction or compression rolls and other mechanical means. The fabric is then transferred to a second surface, for example a bonding wire. The process line may also include one or more bonding devices such as a through-air bonder (TAB) 80. Through-air bonders are known and are therefore not disclosed here in detail. Generally, the through-air bonder 80 directs hot air through one or more nozzles against the filament web on the surface and the support wire 75 below. Hot air from the nozzle of the through-air bonder 80 flows through the web and the forming surface and bonds the filaments of the web together to consolidate and form an integrated web, a fabric. Alternatively or in addition, a more conventional through-air bonder that includes a perforated roller may be included in the methods of the present invention. Lastly, the process line includes a winding roll 90 for taking up the nonwoven fabric. Those of skill in the art will appreciate that the nonwoven fabric making process need not necessarily include two wires and that the same results can be accomplished with a continous wire that extends from the forming region through the bonder region.

To operate the illustrated process line, the hoppers of extruders 20A and 20B are filled with the respective polymer components A and B. Polymer components A and B are melted and extruded by the respective extruders through polymer conduits and the spinneret 30. Although the temperatures of the molten polymers vary depending on the polymers used, when polypropylene and polyethylene are used as primary component A and adhesive component B respectively, the desirable temperatures of the polymers range from about 370° F. to about 530° F. and desirably range from 400° F. to about 450° F. As the extruded filaments 10 extend below the spinneret 30, a stream of air from the quench blower 40 at least partially quenches the filaments and may be used to develop a latent crimp in the filament if desired. Desirably, the quench air flows in a direction substantially perpendicular to the length of the filaments at a temperature of from about 45° F. to about 90° F. and at a velocity from about 100 feet per minute to about 400 feet per minute. The filaments should be quenched sufficiently before being collected on the forming surface 60 so that the filaments can be arranged by forced air passing through the filaments and the forming surface. Quenching the filaments reduces the tackiness of the filaments so that the filaments do not adhere to one another too tightly before being bonded and can be moved or arranged on a forming surface during collection of the filaments on the forming surface and formation of the fabric. After quenching, the filaments are drawn into the vertical passage of the fiber draw unit 50 by a flow of air through the fiber draw unit. The fiber draw unit is desirably positioned 30 to 60 inches below the bottom of the spinneret 30.

In yet another embodiment, at least one additional skin treatment additive is topically or externally applied to fibers, fabrics, films and foams that already include an internal skin treatment additive to provide fibers, fabrics, films or foams having an additional skin treatment benefit and/or to improve the skin treatment benefit of fibers, fabrics, films or foams. It is desirable to include more than one skin treatment additive in fibers, fabrics, films and foams to provide fibers, fabrics, films and foams with multiple skin treatment benefits and/or to improve the skin treatment benefit(s) of such fibers, fabrics, films and foams. For example, a first skin treatment additive, such as dimethicone, can be melt blended into a thermoplastic resin and then used to form a nonwoven fabric or fibers that make up a nonwoven fabric to allow increased loading and retention of a second, other skin treatment additive, such as clay. Clay particles can be coated or otherwise deposited on the surface of the fibers or nonwoven fabric. In another example, a lipid can be melt blended into a thermoplastic composition that is formed into fibers, nonwoven fabrics or films. Then, clay particles or a botanical extract can be applied to the surface of the fiber, fabric or film to provide a fiber, fabric or film with more than one skin treatment benefit, a first skin treatment benefit from the lipid and a second skin treatment benefit from the clay or botanical extract or the clay and botanical extract can be co-administered to provide fiber, fabric or film with multiple skin treatment benefits. It is believed that the addition of dimethicone significantly enhances clay capture efficiency on the surface of the fiber, fabric, film, foam or other substrate that includes dimethicone as an internal additive. Thus, in one embodiment the present invention provides a method of providing clay particles on the surface of a substrate such as a nonwoven fabric that does not require the incorporation of the clay particles into a semi-solid such as an ointment.

As discussed above, an additional skin treatment additive or two more skin treatment additives may be topically applied or otherwise added to the surface of the fibers, nonwoven fabrics, films or foams to provide additional second skin treatment benefit or to further improve the skin treatment benefit of the fibers, fabrics, films or foams. The additional skin treatment additive(s) may be topically applied or otherwise added to the surface of the fibers, fabrics, films or foams by: (a) electrostatic pinning of particles of a skin treatment additive or particles that include at least one skin treatment additive on at least a portion of the outer surface of the fiber, fabric, porous film or foam; (b) spraying a solution, emulsion or other mixture that includes the at additional skin treatment additive on at least a portion of the outer surface of the fiber, fabric, porous film or foam; (c) heating at least a portion of the outer surface of the fiber, fabric, porous film or foam and then depositing particles that include the additional skin treatment additive on at least a portion of the outer surface of the fiber, fabric, porous film or foam; (d) depositing particles that include the additional skin treatment additive on at least a portion of the outer surface of fiber, fabric, film or foam and then heating at least the portion of the outer surface of the fiber, fabric, film or foam; and/or (e) coating or attaching the additional skin treatment additive or a solution or mixture that includes the additional skin treatment additive on at least a portion of the outer surface of fiber, fabric, film or foam. As used herein, “attaching” includes adhering, affixing, coating, affixing or securing including adhering, affixing, coating, affixing or securing with the use of another species or intermediate.

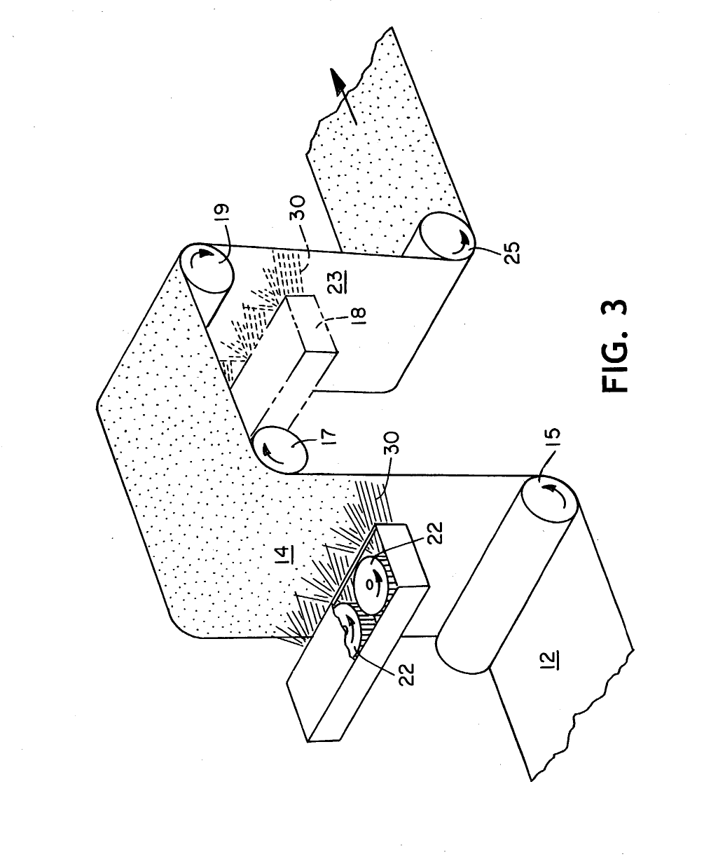

An exemplary process for externally applying a liquid solution or mixture that includes as a component an externally applied skin treatment additive to one or both sides of a traveling nonwoven fabric is illustrated in FIG. 3. It should be appreciated by those skilled in the art that the invention is equally applicable to inline treatment or a separate, offline treatment step. Fabric 312, for example a spunbond or meltblown nonwoven fabric, is directed under support roll 315 to a treating station including rotary spray heads 322 for application to one side 314 of web 312. An optional treating station 318 (shown in phantom) which includes rotary spray heads can also be used to apply the same treatment composition or another treatment composition to opposite side 323 of web 312 directed over support rolls 317 and 319. Each treatment station receives a supply of treating liquid 330 from a reservoir (not shown). The treated web may then be dried if needed by passing over dryer cans (not shown) or other drying means and then under support roll 325 to be wound as a roll or converted to the use for which it is intended.

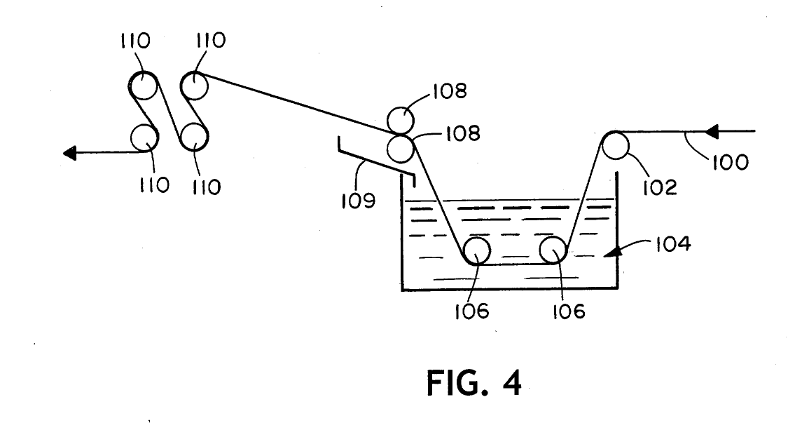

FIG. 4 illustrates an alternative arrangement and method of applying a treatment composition of the present invention. The process illustrated in FIG. 4 is refereed to as a “dip and squeeze” process. In the dip and squeeze process, a substrate is contacted with a bath containing the treating formulation, typically by immersing the substrate in the bath. The substrate can then be nipped at a controllable pressure between two rubber rollers to remove excess saturant. Bath concentration, nip pressure and line speed are parameters that control add-on level on the substrate. The nip between squeeze rolls 408 removes excess treating composition which is returned to the bath by catch pan 409. Drying cans 410 remove remaining moisture. If more than one treatment composition is employed, the dip and squeeze may be repeated and the substrate for example a fabric, film or foam 400 can be forwarded to and immersed in additional baths (not shown).

The second skin treatment additive and other optional treatment can be applied to the fiber, fabric, film or foam after the fibers, fabric, film or foam has been formed and even after the fiber, fabric, film or foam has been converted into an article, for example a diaper, by any of the above-listed processes. Skin treatment additives that are not thermally stable or that do not bloom to the surface should be topically applied to the surface of a fiber, fabric, film or foam instead of incorporating the skin treatment additive as an internal melt additive. Suggested skin treatment additives that may be topically applied include, but are not limited to: clays including both natural and synthetic clays such as kaolin and LAPONITE clays, and aluminum silicates; aluminum hydroxides; talcs; zinc oxides; zinc acetates; zinc carbonates; silver oxides; titanium oxides; talc particles; boron nitride particles; cornstarch; polylactic acid; biopolymers such as hyaluronic acid, chitosan and chemically-modified sulfated chitosans; botanical extracts, such as chamomile, lavender, teas that include green, black and white teas, aloe vera, echinacea, yucca, willow herb and other herbal extracts; moisturizing agents and humectants such as glycerin and related polyols; D-panthenol; emollients such as triglycerides and Di-PPG-3 myristyl ether adipate; skin treatment ingredients that help prevent skin damage or that temporarily protect the skin barrier such as fatty acids, ceramides, lanolin, butters such as cocoa butter, oils such as shark liver oil; vitamins such as Vitamin A, B₅, B₁₂, D and E; anti-inflammatory agents such as β-glucan, β-glucan derivatives, licorice extract and oat extracts; astringents such as witch hazel extract; and agents that relieve inflamed or irritated skin such as allantoin. Skin treatment additives such as fatty acids and fatty alcohols; skin protectants that help prevent skin damage or that temporarily protect the skin barrier such as lanolin, butters such as cocoa butter, oils such as shark liver oil; agents that relieve inflamed or irritated skin such as allantoin and witch hazel; and enzyme inhibitors can be applied either through internal melt addition or through topical application as long as the skin treatment additive(s) can withstand melt processing without significant degradation or is incorporated in a manner in which the additive survives melt processing without significant degradation and is available for skin treatment.

In at least one embodiment, particles of at least one skin treatment additive are deposited and/or attached on at least a portion of the outer surface of fibers, including fibers that are included in or that make up a nonwoven fabric. Particulate skin treatment additives that are potential topical candidates for either providing a skin treatment benefit or preventing or lessening the effect(s) of a skin irritation such as diaper rash are suggested. Particulate skin treatment additives are known and include, but are not limited to, clays including both natural and synthetic clays such as kaolin and LAPONITE clays, aluminum silicates, aluminum hydroxides, talcs, zinc oxides, zinc acetates, zinc carbonates, silver oxides, titanium oxides and cornstarch. Still other skin health additives that may be applied to the exterior surface include, but are not limited to alumina, hydroxyapatite, derivatized carbohydrates such as cellulose, cyclodextrins, silica, activated charcoal, analgesics, antihistamines and anitoxidants. Still yet other potential additives include enzyme inhibitors, vitamins, chelating agents emollients, preservatives, buffering compositions, antimicrobials and so forth. The efficacy of a skin treatment additive that does not readily migrate to the surface if used as an internal melt additive, for example a particulate skin treatment additive, can be enhanced by topically applying the skin treatment additive instead of incorporating the skin treatment additive internally or in the melt. The skin health additive, for example alumina or silica, can be derivatized to enhance or impart affinities for the charged or hydrophobic materials.

One suggested class of particulate skin treatment additives for topical application include clay particles that may be coated onto or otherwise topically applied to the fibers to absorb water or sequester irritants. Clay particles can be applied by electrostatic pinning after the Fiber Draw Unit (FDU) and before the bonder, spraying before the bonder, depositing on activated binder fibers in the bonder or after the bonder and by methods including, but not limited to, slot coating, printing and spraying. The particles are preferably blown onto the stream of particles shortly after the fibers leave an extrusion nozzle and the particles may be given an electrostatic charge prior to contacting the fibers which helps to separate the particles in the fabric. An electrostatic charge is desirably applied to the particles to promote individual particle separation in the composite, as gravity drops the particles into the air stream.

Natural clays include montmorillonite, bentonite, beidellite, hectorite, saponite, stevensite, magnesium aluminum silicates and similar clays. Suggested clays also include synthetic clays including, but are not limited to, synthetic analogs of natural clays, such as LAPONITE synthetic clays available from Southern Clay Products, Inc. of Gonzales, Tex. LAPONITE synthetic clay is sodium magnesium silicate, a synthetic analog bentonite clay. The present invention is demonstrated by the use of LAPONITE XLG clay particles (having an average particle size of about 100 micrometers) in the Examples that follow. LAPONITE XLG clay has the following empirical formula, Na_{0.7}^{0.7+}[(Si₈Mg_{5.5}Li_{0.3})O₂₀(OH)₄]^{0.7-}. Clays may be used as sequestrants and utilized as a skin treatment additive of the present invention, particularly a topically or externally applied skin treatment additive. Both treated and untreated clay particles and layered silicate particles can be used as skin treatment additives in the present invention. In one exemplary embodiment, the present invention is illustrated by the use of clay particles as an externally applied skin treatment additive. Commercially available synthetic clays utilizable in the present invention include various grades of LAPONITE clays, a colloidal synthetic layered silicate available from Southern Clay Products, Inc. Clay particles having a pretreated or organically modified surface absorb organic substances more readily and are suitable as an additional filler component of the compositions of the present invention. Clay particles having a pretreated or modified surface are generally referred to herein as organoclays and organically modified clays. Suggested organically modified or treated clays include, but are not limited to, one or more of the following: ORGANOCLAY CLAYTONE APA, activator-free dimethyl benzyl (hydrogenated tallow) ammonium bentonite; CLAYTONE HY, activator-free, quaternary ammonium compound-modified bentonite; CLAYTONE 40, dimethyl-bis (hydrogenated tallow) ammonium bentonite; and three organically modified clays obtained from Southern Clay Products, Inc. of Gonzales, Tex. and designated as SCPX-1121, SCPX-1122 and SCPX-1123.

An external skin treatment additive can be included on the surface of the fibers, films, foams or fabrics of the present invention by any of various know methods. For example, a skin health additive can be applied or attached to the exterior surfaces or a portion of the exterior surfaces by methods such as solution spraying, coating or electrostatic pinning. Electrostatic pinning is known and is described in U.S. Pat. No. 6,294,222 to Cohen et al. which is incorporated herein in their entirety by reference thereto for all purposes. Generally, electrostatic pining involves electrically charging the base material, for example polyolefin fibers as they are exiting the FDU, by applying a voltage directly across the fibers and directing particles toward the charged fibers. Some of the particles will adhere to the charged fibers. The fibers that are adhered to the fiber surfaces can then be more permanently attached to the surfaces by other means, for example by heating the particles and/or the fibers. The particles can be heated and adhered using electrostatic energy such as microwaves which heat the particles. Heating fixes or otherwise stabilizes the particles on the surfaces. In the instance of bicomponent or multicomponent fibers, the fibers can be heated to the melting point of the lowest melting component. It may also be desirable to physically trap particles of an additive with the voids in a nonwoven web or a foam. Additionally, one or more internal additives can be included one of which will increase the ability of fibers to attract or adhere an exterior additive.

The present invention is further illustrated by the following examples which are representative of the invention although other examples will be apparent to those skilled in the art and are intended to be covered by the claims.

### EXAMPLE 1

Nonwoven fabrics and fibers were produced by a bicomponent spunbond process. In this Example 1 and the Examples that follow, base nonwoven materials were formed from continuous bicomponent filaments under the conditions described herein. In the Examples that follow, skin treatment additives that were blended or otherwise included in the nonwoven fabrics. In this Example 1, bicomponent filaments were made from approximately equal amounts of two polymer components in a side-by-side configuration. The composition of the first component was 100 percent by weight of 3445 polypropylene from Exxon of Houston, Tex. The composition of second component was 100 percent by weight of XUS 61800.41 polyethylene from Dow Chemical Company of Midland, Mich. These polymers were spun through standard spin hole geometries to create side by side fibers with 50 percent of the fiber containing polypropylene and 50 percent of the fiber containing polyethylene. The fibers were quenched and drawn as standard in the industry and described in the previously incorporated patent to Pike et al. The fibers were then placed on a forming belt prior to collecting a nonwoven fabric formed from the entangled fibers. A sample of the fabric was collected for analysis to a comparative example.

### EXAMPLE 2

In Example 2, a nonwoven fabric was produced as stated in above Example 1 except that MASIL SF19 surfactant was included in the polypropylene side of the side-by-side bicomponent fibers of the nonwoven fabric. The MASIL SF19 surfactant was obtained from BASF of Gurnee, Ill. and was compounded in polypropylene at a concentration of 10 weight percent prior to melt blending into the final composition. The composition of the polypropylene side of the bicomponent fibers component consisted of 2 parts by weight of MASIL SF19 surfactant blended with 98 parts by weight of Exxon 3445 polypropylene. The composition of the other side of the bicomponent fibers remained 100 percent by weight of XUS 61800.41 polyethylene. A sample of fabric was collected for analysis.

### EXAMPLE 3

In Example 3, the bicomponent filaments were produce as stated in Example 1, except the addition of MASIL SF19 surfactant and a lipid, specifically a phytosterol, more specifically GENEROL 122 N PRL soy sterols was blended into the polypropylene side of the fiber. The soy sterols were compounded into polypropylene at a concentration of 20 weight percent prior to melt blending in the final, nonwoven fiber composition. Dimethicone, namely Dow Corning® MB50-001 Silicone Masterbatch (Dow Corning Corporation, Midland, Mich.) compounded in polypropylene at a concentration of 50 weight percent was blended into the polyethylene side of the fiber. The final composition of the first component was 96.5 percent by weight of 3445 polypropylene from Exxon of Houston, Tex., 2 percent by weight of MASIL SF19 surfactant and 1.5 percent by weight of GENEROL soy sterols. The composition of second component was 96 percent by weight of XUS 61800.41 polyethylene from Dow Chemical Company of Midland, Mich., 2 percent by weight of 3445 polypropylene, and 2 percent by weight of the dimethicone. A sample of fabric was collected for analysis.

### EXAMPLE 4

In Example 4, the bicomponent filaments were produced as stated in Example 1, except with the addition of MASIL SF19 surfactant and GENEROL 122 N PRL soy sterols blended into the polypropylene side of the fiber. The composition of the first component was 96.5 percent by weight of 3445 polypropylene from Exxon of Houston, Tex.; 2 percent by weight of MASIL SF19 surfactant; and 1.5 percent by weight of the soy sterols. The composition of second component was 100 percent by weight of XUS 61800.41 polyethylene from Dow Chemical Company of Midland, Mich. A sample of fabric was collected for analysis.

### EXAMPLE 5, 6, 7 and 8

The bicomponent filaments of nonwoven fabrics of Examples 1, 2, 3, and 4 were coated with a low level add-on of LAPONITE G clay particles (about 2 weight percent add-of clay to weight of nonwoven fabric) to produce Examples 5, 6, 7 and 8, respectively. The LAPONITE G clay particles had an average particle size of about 100 micrometers and were obtained from Southern Clay Products, Incorporated of Gonzales, Tex. Each portion of fabric was weighed before the addition of any clay particles. Clay particles were then contacted to and dispersed on the surfaces of the respective nonwoven fabric by placing a portion of the fabric and an excess of the clay particles in a container, sealing the container and shaking the container and contents to distribute clay particles onto and the nonwoven fabric, more specifically onto the fibers and/or filaments that made up the fabric. The fabric was then weighed to determine if the desired amount of clay particles, 2 weight percent, was attached to, entrapped in or otherwise attracted to the fabric surface. If less weight of clay was desired the fabric was agitated or shaken to remove clay. After the desired amount of clay was measured, each of the fabric examples was then exposed to heat for about 60 seconds at about 130° C. (about 280° F.) to adhere and more permanently fix the clay particulates to the fibers by slightly melting the polyethylene side of the fiber. A sample of each fabric was collected for analysis.

### EXAMPLE 9, 10, 11 and 12

The bicomponent filaments of nonwoven fabrics of Examples 1, 2, 3, and 4 were coated with a high level add-on of LAPONITE G clay particles (about 12 weight percent add-on level) using the same method to produce Examples 9, 10, 11 and 12, respectively. Each of the examples was then exposed for 60 seconds about 280° F. heat to adhere or otherwise affix the clay particulates to the fibers by slightly melting the polyethylene side of the fiber. A sample of each fabric was collected for analysis.

TABLE 1

| | | GENEROL | | | | |
|---|---|---|---|---|---|---|
| | | 122 N PRL | MASIL | | Dimethicone | LAPONITE |
| Example | PP | Lipid | SF19 | PE | in PP(50/50) | clay add-on |
| 1 | 100 wt % | — | — | 100 wt % | — | — |
| 2 | 98 wt % | — | 2 wt % | 100 wt % | — | — |
| 3 | 96.5 wt % | 1.5 wt % | 2 wt % | 96 wt % | 4 wt % | — |
| 4 | 96.5 wt % | 1.5 wt % | 2 wt % | 100 wt % | — | — |
| 5 | 100 wt % | — | — | 100 wt % | — | +2 wt % |
| 6 | 98 wt % | — | 2 wt % | 100 wt % | — | +2 wt % |
| 7 | 96 wt % | 1.5 wt % | 2 wt % | 96 wt % | 4 wt % | +2 wt % |
| 8 | 96 wt % | 1.5 wt % | 2 wt % | 100 wt % | — | +2 wt % |
| 9 | 100 wt % | — | — | 100 wt % | — | +12 wt % |
| 10 | 98 wt % | — | 2 wt % | 100 wt % | — | +12 wt % |
| 11 | 96.5 wt % | 1.5 wt % | 2 wt % | 96 wt % | 4 wt % | +12 wt % |
| 12 | 96.5 wt % | 1.5 wt % | 2 wt % | 100 wt % | — | +12 wt % |

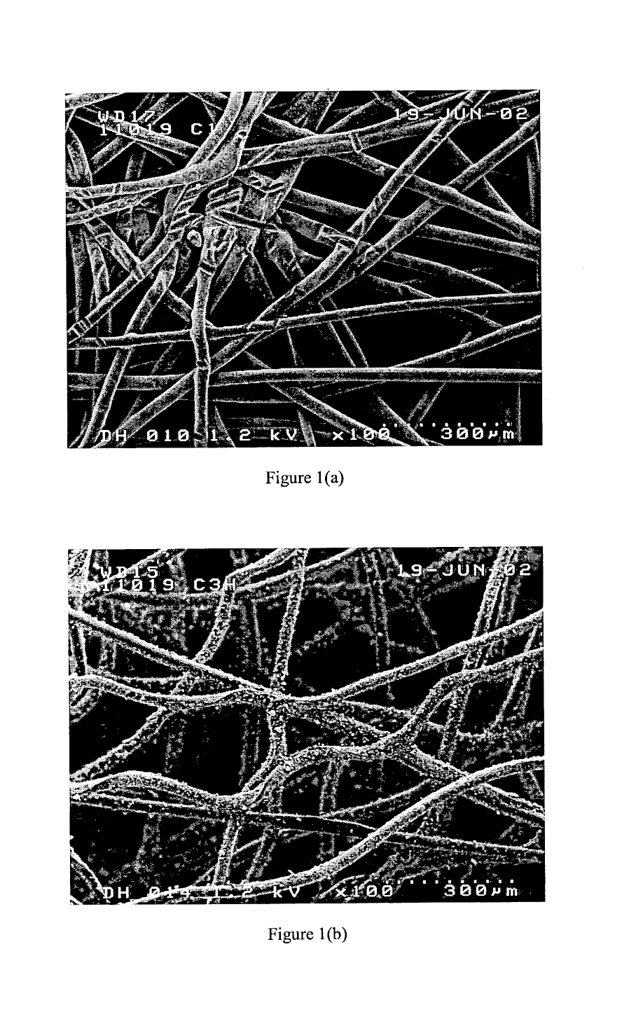

A scanning electron micrograph of a comparative example, Example 1, is provided in FIG. 1(a). FIG. 1(a) is a scanning electron micrograph of spunbonded fibers that do not include any external skin health additives. FIG. 1(b) is a scanning electron micrograph of a example of the present invention and shows spunbonded fibers that include a lipid, namely GENEROL 122 N PRL soy sterols, as a internal skin health additive and clay particles, namely LAPONITE XLG clay particles, as an external skin health additive. The clay particles were topically applied to the fibers and heat fused to the fibers as described in these examples.

### Protease Adsorption Analysis

Materials of the Examples 7 and 8 with both internal skin treatment additives (soy sterols and/or dimethicone) and an external skin treatment additive at two weight percent (LAPONITE XLG clay) were compared to the material of Example 6 with only the external skin treatment additive at two weight percent for their effectiveness to adsorb a fecal irritant (trypsin). Additionally, materials of the Examples 11 and 12 with soy sterols and/or dimethicone and LAPONITE XLG clay at twelve weight percent were compared with the material of the Example 10 with only the clay additive at twelve weight percent. Samples of each of the materials were obtained by using a standard punch to cut a 0.9 centimeter diameter circle (0.64 centimeter²) from the nonwoven fabric of each of the respective Examples. Circles of material were placed in 1.7 milliliter siliconized microcentrifuge tubes containing 500 microliters of sodium acetate buffer (50 millimolar sodium acetate, 0.15 molar sodium chloride pH 5.5). After a short incubation at room temperature to confirm that the materials were wettable, a 500 microliter aliquot of 4 micrograms/milliliter of pancreatic trypsin in sodium acetate buffer was added to the tube and samples mixed on a Vari-Mix rocker for 15 minutes. Trypsin (T-0134, 15,900 Units/milligram) from porcine pancreas was purchased from Sigma Chemical Company of St. Louis, Mo.

Triplicate measurements were performed for each Example. A 400 microliter aliquot was removed and centrifuged at 5,000 rpm for 10 seconds using an Eppendorf 5415C Microcentrifuge from VWR Scientific Products of Chicago, Ill. through 0.22 micron cellulose acetate membrane inserts (Spin X®, Catalog #8161 from Corning Costar Corporation of Cambridge, Mass.). A 250 microliter aliquot was added to the first column of a 96 well plate (Falcon® 96 Well U Bottom Plate from VWR Scientific Products of Chicago, Ill.) and then serially diluted two-fold with sodium acetate buffer along the entire row. Trypsin activity remaining was determined for samples diluted at 256 fold using a Fluoroskan Ascent Fluorometer from Thermo Labsystems of Franklin, Mass. One-hundred microliters of 50 micromolar trypsin peptide substrate, Boc-Gln-Ala-Arg-AMC HCl in 100 millimolar Tris-HCl buffer, pH 8.0 (25 millimolar stock solution of substrate prepared in dimethylformamide) was added to Dynex white 96 well plates containing 100 microliters of sample. Trypsin fluorogenic peptide substrate (Boc-Gln-Ala-Arg-AMC HCl) was purchased from BACHEM Bioscience of King of Prussia, Pa. All other components and reagents were obtained from Sigma Chemical Company and were the highest grade available.

Reaction rates (Relative Fluorescent Units/minute) were determined using a linear part of the reaction curve from 2 to 7 minutes using 355 nm excitation and 460 nm emission filters. Mean values from each set of triplicate samples were determined and used to determine Percent Trypsin Activity Remaining. Percent Trypsin Activity Remaining was calculated as (V_{c}/Vₒ)*100, where V_{c} is the rate of substrate cleavage by trypsin after incubation with the skin treatment additive(s) surfactant-treated nonwoven materials and Vₒ is the rate of substrate cleavage by trypsin with only the surfactant-treated material. These values were then converted into Percent Trypsin Bound by subtracting these values from 100. The Amount of Trypsin Bound to the circles of nonwoven material was calculated as follows: Percent Trypsin Bound/100*2000. The total amount of trypsin in the reaction tube was 2000 nanograms. These values were then converted to Amount of Trypsin Bound per centimeter² of nonwoven material by dividing the Amount of Trypsin Bound by 0.64. Table 2 shows the Amount of Trypsin Bound per centimeter² of nonwoven fabric for the low and high clay Examples from Table 1.

TABLE 2

| | Trypsin | | Amount of | Amount of Trypsin | |
|---|---|---|---|---|---|
| | Activity | Trypsin | Trypsin | Bound/centimeter² | |
| | Remaining | Bound | Bound | of nonwoven | Number of |
| Example | (Percent) | (Percent) | (nanograms) | material | Experiments |
| 6 | 66.3 | 33.7 | 674 | 1053.1 | 4 |
| 7 | 57.3 | 42.7 | 854.0 | 1334.4 | 3 |
| 8 | 72.3 | 27.7 | 554.0 | 865.6 | 3 |
| 10 | 2.1 | 97.9 | 1958.0 | 3059.4 | 3 |
| 11 | 2.5 | 97.5 | 1950.0 | 3046.9 | 2 |
| 12 | 20.5 | 79.5 | 1590.0 | 2484.4 | 2 |

Theoretical amount of trypsin bound to nonwoven material=3125 nanograms/centimeter². Data represent mean values.

No statistical difference (Student's t-test) was found between the sample codes with low levels of clay or those codes with higher levels of clays, indicating that the addition of other skin treatment additives (i.e., soy sterols and dimethicone) to the nonwoven fabric do not adversely effect the adsorption properties of the clay. These data show that nonwoven materials can be made with multiple skin treatment additives that impart a number of skin heath attributes using unique processing methods.

### Stability of GENEROL 122 N PRL Soy Sterols Blended into Nonwoven Materials

Nonwoven materials were cut into pieces and about 25 milligrams placed into 10 milliliter volumetric flasks. The nonwoven materials were extracted with 6-7 milliliters of 100% denatured alcohol with heating at 65° C. for 20 minutes, sonicating for 20 minutes, and shaking with a wrist shaker (Lab-Line from VWR Scientific Products of Chicago, Ill.) at scale 8 for 20 minutes to extract the soy sterols. The extracts were then diluted to scale with the same solvent. Each of these extracts was concentrated ten times before Gas Chromatography analysis. Sterol references (cholesterol, stigmasterol, and β-sitosterol) purchased from Sigma Chemical Company of St. Louis, Mo. were used in the analysis. Approximately 5 milligrams of each of the reference standards were weighed out into a 50 milliliter volumetric flask and dissolved in 100% denatured alcohol with sonication. In addition, a reference sample of the GENEROL 122 N PRL soy sterols used to form the fabrics was prepared. Approximately 50 milligrams of the soy sterol sample was weighed out into a 25 milliliter volumetric flask and dissolved completely in 100% denatured alcohol with sonication.

Gas Chromatography conditions used were as follows:

Gas Chromatography column: J&W, DB-1HT, 15 meter, 0.32 millimeter, and 0.1 micrometer.

Gas Carrier: Helium.

Flow rate: 16 milliliters/minute

Detection: Flame Ionization Detector.

Injection volume: 5 microliters with Split at 10:1

Injector temperature: 280° C.

Detector temperature: 360° C.

Oven temperature: 180° C. hold for 5 minutes, go up to 260° C. at 5° C./minute then hold for 5 minutes.

Retention time of soy sterols: cholesterol 15.25 minutes, brassisterol 15.82 minutes, campesterol 16.56 minutes, stigmasterol 16.99 minutes, and β-sitosterol 17.67 minutes. Brassisterol and campesterol peaks were identified based on their boiling points and a literature source (Journal Food and Drug Analysis, 1999, 7:279.)

Ratios of GENEROL122 N PRL soy sterols used to form the fabric and soy sterols extracted from the fabric were calculated based on their Gas Chromatography peak areas. Table 3 lists the calculated ratio of each soy sterol to β-sitosterol (where the peak area of β-sitosterol is assumed to be 100 units). Example 2 from Table 1 which does not include lipid did not have any of the peaks corresponding to the soy sterol reference standards. Examples 3,4,7,8,11 and 12 from Table 1 in which soy sterols were blended into the nonwoven material had calculated ratios similar to the GENEROL122 N PRL soy sterols used to form the fabric. This indicates that GENEROL122 N PRL soy sterols (and presumably related lipid materials) are retained during processing and do not degrade significantly during formation of the fiber and nonwoven web.

TABLE 3

| Sample | Cholesterol | Brassicasterol | Campesterol | Stigmasterol | β-Sitosterol* |
|---|---|---|---|---|---|
| Soy sterol | 0.8 | 8.4 | 54.5 | 39.1 | 100.0 |
| used to form | | | | | |
| fabric | | | | | |
| Example 2 | 0 | 0 | 0 | 0 | 0 |
| Example 3 | 1.0 | 8.8 | 51.3 | 34.6 | 100.0 |
| Example 7 | 1.1 | 8.4 | 49.9 | 34.1 | 100.0 |
| Example 11 | 0.9 | 8.4 | 51.0 | 34.5 | 100.0 |
| Example 4 | 0.9 | 8.9 | 50.9 | 34.9 | 100.0 |
| Example 8 | 1.0 | 8.9 | 51.6 | 35.3 | 100.0 |
| Example 12 | 0.7 | 8.3 | 52.5 | 33.5 | 100.0 |

β-Sitosterol is assumed to be 100 units.

Thus, in accordance with the invention, there has been provided a method of including one or more skin treatment additives in a fiber, fabric, film or foam and fibers, fabrics, films or foams that include one or more skin treatment additives. While the invention has been illustrated by specific embodiments, it is not limited thereto and is intended to cover all equivalents as come within the broad scope of the claims.

We claim:

1. A method of forming a fiber, a nonwoven fabric, a porous film or a foam the method comprising:
a. blending a thermoplastic resin and at least one melt additive, wherein the at least one melt additive is a first skin treatment additive;
b. forming a fiber, a nonwoven fabric, a porous film or a foam from a blend comprising the thermoplastic resin and the at least one melt additive; and
c. attaching at least one external additive on at least a portion of the outer surface of the fiber, nonwoven fabric, porous film or foam wherein the at least one external additive is a second skin treatment additive.

2. The method of claim 1 wherein the attaching of at least one external additive on at least a portion of the outer surface of the fiber, nonwoven fabric, porous film or foam is selected from the group consisting of:
a. pinning particles of an external additive or particles comprising at least one external additive on at least a portion of the outer surface of the fiber, nonwoven fabric, porous film or foam;
b. spraying a solution, emulsion or other mixture comprising the at least one external additive on at least a portion of the outer surface of the fiber, nonwoven fabric, porous film or foam;
c. heating at least a portion of the outer surface of the fiber, nonwoven fabric, porous film or foam and then depositing particles comprising at least one external additive on at least a portion of the outer surface of the fiber, nonwoven fabric, porous film or foam;
d. heating at least a portion of the outer surface of the fiber, nonwoven fabric, porous film and depositing particles comprising at least one external additive on at least a portion of the outer surface of the fiber, nonwoven fabric, porous film or foam;
e. depositing particles comprising the at least one external additive on at least a portion of the outer surface of fiber, nonwoven fabric, porous film or foam and then heating at least the portion of the outer surface of the fiber, nonwoven fabric porous film or foam; and
f. coating at least one external additive on at least a portion of the outer surface of fiber, nonwoven fabric, porous film or foam.

3. The method of claim 1 wherein the at least one melt additive is selected from the group consisting of polydimethyl siloxane compounds, alkyl silicones, phenyl silicones, amine-functional silicones, silicone gums, silicone resins, silicone elastomers, dimethicones, dimethicone copolyols and lipids and derivatives thereof.

4. The method of claim 1 wherein the at least one melt additive is a dimethicone.

5. The method of claim 1 wherein the at least one melt additive is a lipid.

6. The method of claim 1 wherein the at least one melt additive comprises dimethicone and dimethicone gum.

7. The method of claim 1 wherein the at least one melt additive comprises a dimethicone and a silicone resin.

8. The method of claim 1 wherein the at least one melt additive comprises a dimethicone and a silicone elastomer.

9. The method of claim 1 wherein the at least one melt additive is selected from the group consisting of sterols and phytosterols.

10. The method of claim 1 wherein the at least one external additive is selected from the group consisting of botanical extracts, clay particles, talc particles, boron nitride particles, corn starch, zeolites, zinc oxide, glycerin and related polyols, hyaluronic acid, chitosan and chemically-modified sulfated chitosans.

11. The method of claim 1 wherein the at least one melt additive comprises from about 0.1 weight percent to about 10 weight percent of the fiber, nonwoven fabric, porous film or foam.

12. The method of claim 1 wherein the at least one melt additive comprises from about 0.25 weight percent to about 5 weight percent the fiber, nonwoven fabric, porous film or foam.

13. The method of claim 1 wherein the at least one melt additive comprises from about 1 weight percent to about 2 weight percent of the fiber, nonwoven fabric, porous film or foam.

14. A method of forming a fiber, a nonwoven fabric, a porous film or a foam, the method comprising:
a. blending a thermoplastic resin and at least one melt additive, wherein the at least one melt additive is a sterol or a phytosterol, and
b. forming a fiber, a nonwoven fabric, a porous film or foam from the blend comprising the thermoplastic resin and the lipid.

15. The method of claim 14 wherein the lipid is a phytosterol.

16. The method of claim 14 wherein the lipid is a soy sterol.

17. The method of claim 14 wherein the lipid is a refined soy sterol.

18. The method of claim 14 wherein the lipid comprises from about 0.1 weight percent to about 10 weight percent of the fiber, nonwoven fabric, porous film or foam.

19. The method of claim 14 wherein the lipid comprises from about 0.25 weight percent to about 5 weight percent the fiber, nonwoven fabric, porous film or foam.

20. The method of claim 14 wherein the lipid comprises from about 1 weight percent to about 2 weight percent of the fiber, nonwoven fabric, porous film or foam.

21. A multicomponent fiber comprising a blend that comprises a thermoplastic resin and at least one skin treatment additive, wherein the fiber has an outer surface and at least a portion of the outer surface comprises a second skin treatment additive.

22. The multicomponent fiber of claim 21 wherein the at least one skin treatment additive is selected from the group consisting of polydimethyl siloxane compounds, alkyl silicones, phenyl silicones, amine-functional silicones, silicone gums, silicone resins, silicone elastomers, dimethicones, dimethicone copolyols and lipids and derivatives thereof.

23. The multicomponent fiber of claim 21 wherein the at least one skin treatment additive is a dimethicone.

24. The multicomponent fiber of claim 21 wherein the at least one skin treatment additive is a phytosterol.

25. The multicomponent fiber of claim 21 wherein the at least one skin treatment additive is a lipid.

26. The multicomponent fiber of claim 21 wherein the at least one skin treatment additive is selected from the group consisting of sterols and phytosterols.

27. The multicomponent fiber of claim 21 wherein the second skin treatment additive is selected from the group consisting of botanical extracts, emollients, clay particles, talc particles, boron nitride particles, corn starch, zeolites, zinc oxide, glycerin and related polyols, hyaluronic acid, chitosan and chemically-modified sulfated chitosans.

28. The multicomponent fiber of claim 21 wherein the at least one skin treatment additive comprises from about 0.1 weight percent to about 10 weight percent of one the components of the multicomponent fiber.

29. The multicomponent fiber of claim 21 wherein the at least one skin treatment additive comprises from about 0.25 weight percent to about 5 weight percent of one the components of the multicomponent fiber.

30. The multicomponent fiber of claim 21 wherein the at least one skin treatment additive from about 1 weight percent to about 2 weight percent of one the components of the multicomponent fiber.

31. The multicomponent fiber of claim 21 wherein the second skin treatment additive comprises clay particles.

32. The multicomponent fiber of claim 30 wherein the clay particles have an average particle size that is less than 500 micrometers.

33. The multicomponent fiber of claim 21 wherein the second skin treatment additive comprises from about 0.01 weight percent to about 50 weight percent of the multicomponent fiber.

34. The multicomponent fiber of claim 21 wherein the second skin treatment additive comprises from about 0.1 weight percent to about 20 weight percent of the multicomponent fiber.

35. The multicomponent fiber of claim 21 wherein the second skin treatment additive comprises greater than about 10 weight percent of the multicomponent fiber.

36. A nonwoven fabric comprising multicomponent fibers of claim 21.

37. An absorbent article comprising the nonwoven fabric of claim 36.

38. A diaper comprising the nonwoven fabric of claim 36.

39. A bandage comprising the nonwoven fabric of claim 36.

40. A wipe comprising the nonwoven fabric of claim 36.

41. A feminine hygiene product comprising the nonwoven fabric of claim 36.
